(19) United States
(12) Patent Application Publication
(10) Pub. No.: US 2016/0306503 A1
(43) Pub. Date: Oct. 20, 2016

(54) Workflow Guidance Widget with State-Indicating Buttons

(71) Applicant: Jared Keith Youtsey, Colorado Springs, CO (US)

(72) Inventor: Jared Keith Youtsey, Colorado Springs, CO (US)

(73) Assignee: VMware, Inc., Palo Alto, CA (US)

(21) Appl. No.: 14/687,971

(22) Filed: Apr. 16, 2015

(51) Int. Cl. G06F 3/0481

(52) U.S. Cl. CPC G06F 3/0481

(57) ABSTRACT

A workflow guidance widget presents rows of buttons. Each button, when triggered, initiates a procedure for completing a respective task. The spatial order of buttons in a row corresponds to temporal positions of their respective tasks in a workflow. Each button indicates whether or not the respective task has been completed and whether or not the button can be triggered without completing a non-respective task. For hierarchically arranged rows, a button in the parent row ray indicate completeness of a task based on completeness indications in its one or more child rows. Accordingly, a user can tell, at a glance, the current state of the workflow, what actions are required to advance the workflow, and what actions are available without having to complete a non-respective task.

### BACKGROUND

As individuals and corporations increasingly store sensitive information “in the cloud”, protection of online information from unauthorized access has become imperative. Several compliance standards have been issued to provide guidance to system owners and administrators. For example, the Health Insurance Portability and. Act (HIPAA) sets forth standards for protecting the privacy of individually identifiable health information. The Payment Card industry (PCI) Security Standards Council has set forth security standards to enhanced payment account data security. The Data Interchange Standards Association (DISA) defines secure standards for business-to-business data exchanges. In addition to these industry standards, certain vendor-specific standards and user-created standards can apply to a computer system.

Standards are typically proposed as flexible guidelines. A standard can include a number of rules, but not all systems need conform to all rules. Some rules may not be applicable, and some applicable rules may not be cost-effective to implement; also, systems in development may conform to some rules, while other rules are to be addressed in later versions. However, it can be important to know the rules with which a system complies and the rules which are not met.

### BRIEF DESCRIPTION OF THE DRAWINGS

FIG. 1 is a flow chart of a workflow.

FIG. 2 is a representation by a workflow guidance widget of a state of the workflow of FIG. 2.

FIG. 3 is a schematic diagram of a cloud-based computing environment.

FIG. 4 is a schematic representation of a cloud-based computing-system manager computer of the cloud-based computing environment of FIG. 3.

FIG. 5 is a schematic view of a representation by a workflow guidance widget of a state of a workflow for evaluating the cloud-based computing system of FIG. 1 against a set of compliance standards.

FIG. 6 is a screenshot of a “Create Compliance Standard” dialog box for adding a compliance standard to or modifying a compliance standard to the representation of FIG. 5.

FIG. 7 is a screenshot of a “Create Compliance Profile” dialog box for adding or modifying a compliance profile.

FIG. 8 is a screenshot of a “Compliance Profile Assignments” dialog box for assigning system objects to compliance profiles (and vice versa).

FIG. 9 is a screenshot of a “Test Profile” dialog box for testing a compliance profile.

FIG. 10 is a screenshot of an alternative representation by a workflow guidance widget of a state of a workflow for evaluating the cloud-based computing system of FIG. 1 against a set of compliance standards.

FIG. 11 is a screenshot of a workflow guidance widget including a wrap-around row.

FIG. 12 is a screenshot of a workflow guidance widget including a button indicating an invalid state.

FIG. 13 is a flow chart of a process implemented by the to cloud-based computing system manager computer of FIG. 4.

### DETAILED DESCRIPTION

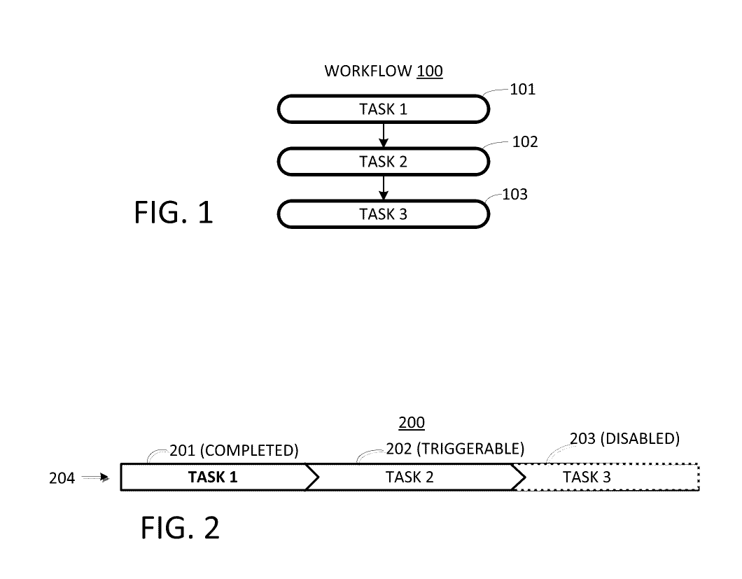

The present invention provides a workflow guidance widget that, at least in some scenarios, provides improved guidance through simple and complex workflows. For example, a simple workflow 100, shown in FIG. 1, consists of a temporally-ordered series of tasks, Task 1 101, Task 2 102, and Task 3 103. Tasks 101-103 are presented in temporal order in that Task 2 normally or necessarily temporally follows Task 1 and Task 3 normally or necessarily follows Task 2. A workflow guidance widget 200 for guiding a user through workflow 100 is shown in FIG. 2.

Widget 200 provides spatially ordered buttons 201, 202, and 203 in a row 204. Note that all buttons of row 204, other than the rightmost button 203, point i.e., with chevrons, to the right to make it apparent that widget 200 pertains to a workflow. The appearance of each of buttons 201-203 changes as the user progresses through the workflow. Button 201 is labeled “Task 1” in bold text. The bolding indicates that the task associated with button 201. has been completed according to a respective criterion. In general, the fact that a task has been completed does not rule out modifications to “recomplete” the task. Accordingly, the outline of button 201 is solid, indicating that button 201 is triggerable (active). Thus, if button 201 as represented in FIG. 2. is triggered, a procedure for modifying the result of Task 1 is initiated.

Button 202 is labeled “Task 2” in regular (non-bold) text. The non-bold text indicates that Task 2 is not complete. The outline of button 202 is solid, indicating that button 202 can be triggered. Triggering button 202 initiates a procedure for completing (or recompleting) Task 2. Button 203 is labeled “Task 3” in regular text, indicating that Task 3 is not complete. The outline of button 203 is dashed, indicating it is disabled. For example, it may be that Task 3 cannot be performed until Task 2 is complete. However, in other workflows, a button can be active even where the task associated with a preceding button has not been completed. Note that the spatial order of buttons 201-203 corresponds to the temporal order of respective workflow tasks 101-103.

A glance at widget 200 indicates: which tasks have been completed and which have not been completed; which buttons can be triggered and which cannot; and which buttons to trigger to complete a task or modify a result of a completed task. A user of widget 200 can easily determine the current state of the represented workflow and the alternative courses of action available to the user. The advantages of such state-indicating workflow guidance widgets are magnified for more complex workflows, such as those that may be involved in setting up and evaluating cloud-based computing systems for compliance to security standards.

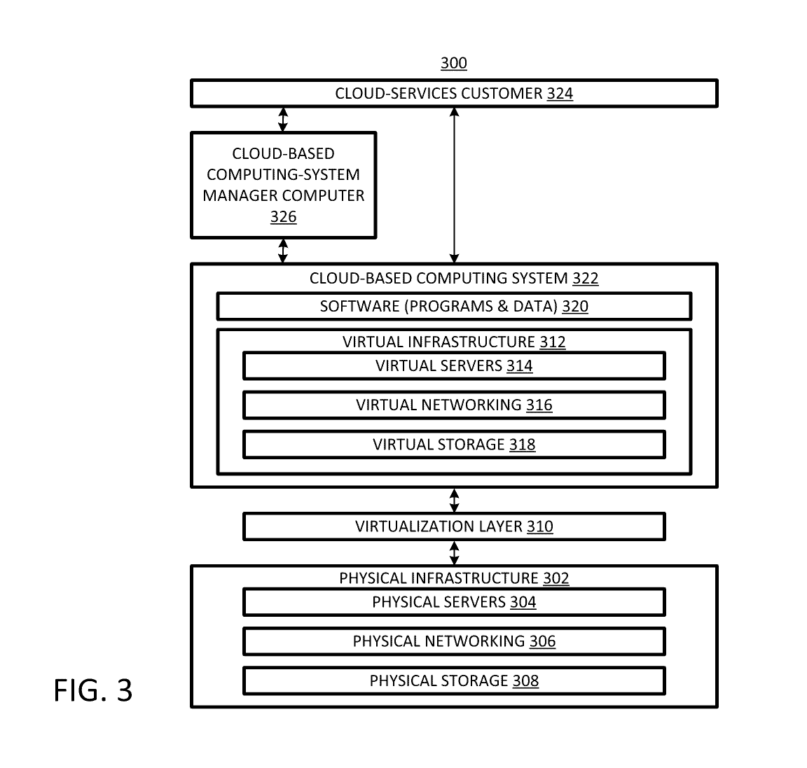

A cloud-based computing environment 300, shown in FIG. 3, serves as a context for an example workflow guidance widget. Environment 300 includes a vendor-managed physical infrastructure 302, including physical servers 304, physical networking 306, and physical storage 308. A vendor-provided virtualization layer 310 virtualizes physical infrastructure 302 to provide for multiple virtual infrastructures, including a customer-managed virtual infrastructure 312. Virtual infrastructure 312 includes virtual servers 314, virtual networking 316, and virtual storage 318. Software 320 can be installed on virtual infrastructure 312 to define a cloud-based computing system 322,

A cloud-services customer 324 can manage cloud-based computing system 322 using vendor-provided cloud-based computing-system manager computer 326. Managing can include designing. modifying, configuring, and testing system 322.

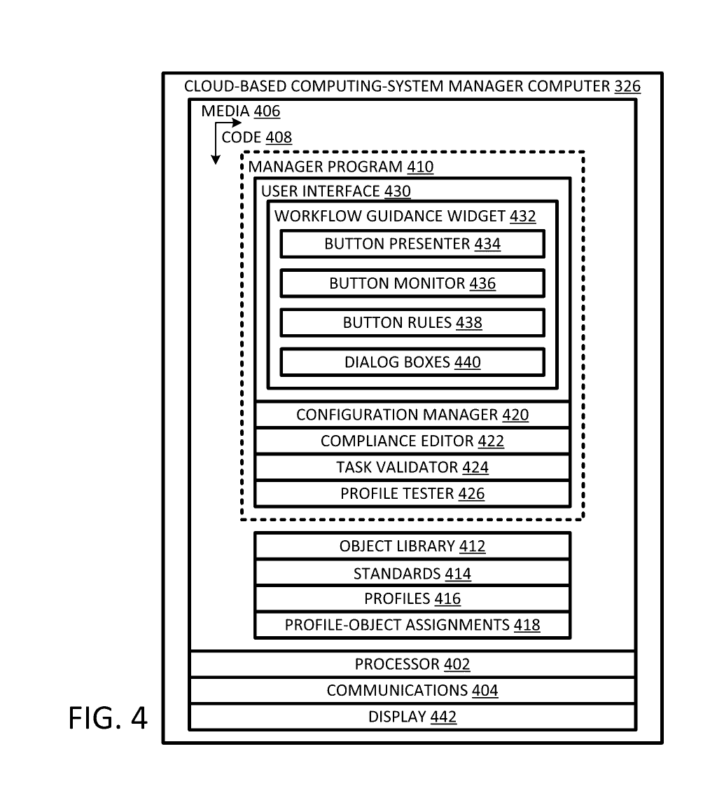

As shown in FIG. 4, cloud-based computing-system manager computer 326 includes hardware, namely, a processor 402, communications devices 404, and non-transitory storage media 406. Media 406 is encoded with code 408 including a manager program 410 and data structures including an object library 412, standards 414, profiles 416, and profile-object assignments 418. Object library 412 is a set of virtual-infrastructure components (virtual servers, virtual network components, and virtual storage devices) and software, and various combinations thereof. Standards 414 include industry compliance standards such as HIPAA and PCI, as well as vendor-specific standards, and user-defined standards. Profiles 416 are default and user-generated sets of rules derived from standards 414. Profile-object assignments 418 are associations of objects and profiles defined such that objects can be evaluated, with respect to associated. profiles.

Manager program 410 includes a configuration manager 420, a compliance editor 422, a task validator 424, and a profile tester 426. Configuration manager 420 is used for configuring virtual-infrastructure components and installing and configuring software to execute on the virtual infrastructure. Compliance editor 422 provides for creating and editing compliance standards 414, compliance profiles 416, and profile-object assignments 418. Task validator 424 is used for monitoring and testing profiles 416.

Manager program 410 provides a user interface 430 to facilitate customer interaction with configuration manager 420, compliance editor 422, and task validator 424. User interface 430 includes a workflow guidance widget 432. Widget 432 includes a button presenter 434, a button monitor 436, button rules 438, and dialog boxes 440. Button presenter 434 displays buttons, e.g., on a display 442, for a user to view and interact with. Button monitor 436 monitors buttons for triggering actions and trigger actions according to button rules 438. Button rules 438 are also used by button presenter 434 to determine how to display buttons (e.g., with bold or regular text labels). Button rules 438 are also used to determine what dialog box 440 or other object is displayed in response to triggering of a button.

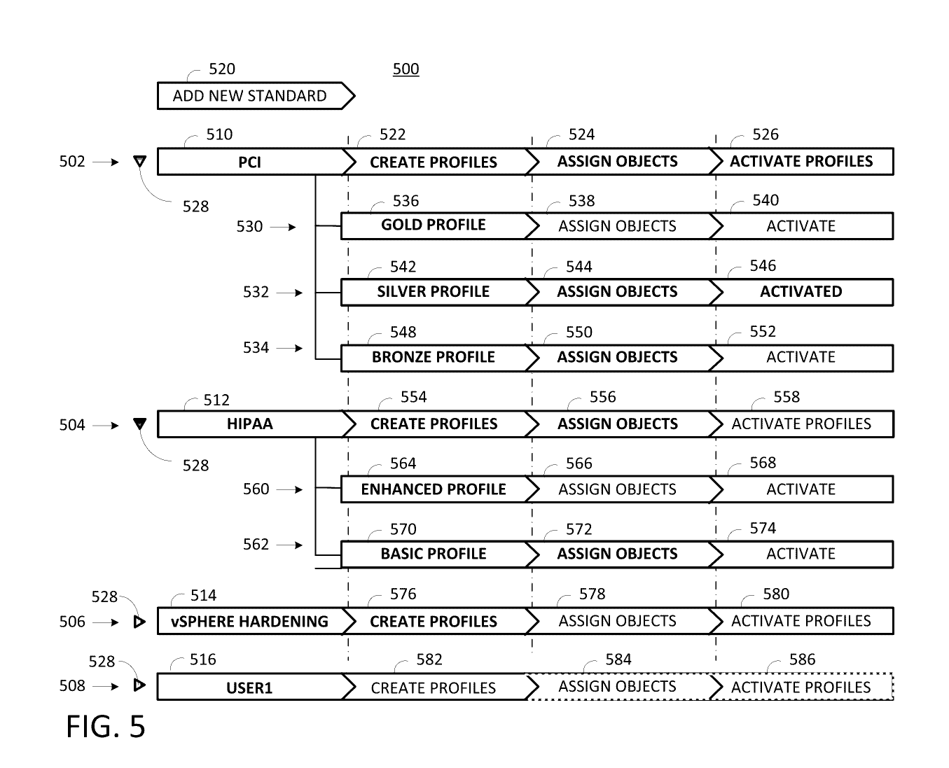

A button presentation 500 of workflow guidance widget 432 is shown schematically in FIG. 5. Presentation 500 includes top-level rows 502, 504, 506, and 508, each of which corresponds to a respective compliance standard. Row 502 corresponds to the PCI compliance standard for payment data. Accordingly, leftmost button 510 of row 502 is labeled “PCI”. Row 504 corresponds to the HIPAA compliance standard for health data, and its leftmost button 512 accordingly is labeled “HIPAA”. Row 506 corresponds to a vendor-specific compliance standard specified in a vSphere Hardening Guide promulgated by VMware, Inc., for its virtualization and cloud-based products; accordingly, the leftmost button 514 of row 506 is labeled “vSphere Hardening”. Row 508 corresponds to a user-created compliance standard, i.e., specification. The user could be or could be acted on behalf of cloud-services customer 324, FIG. 3. The leftmost button 516 of row 508 is accordingly labeled “User1”.

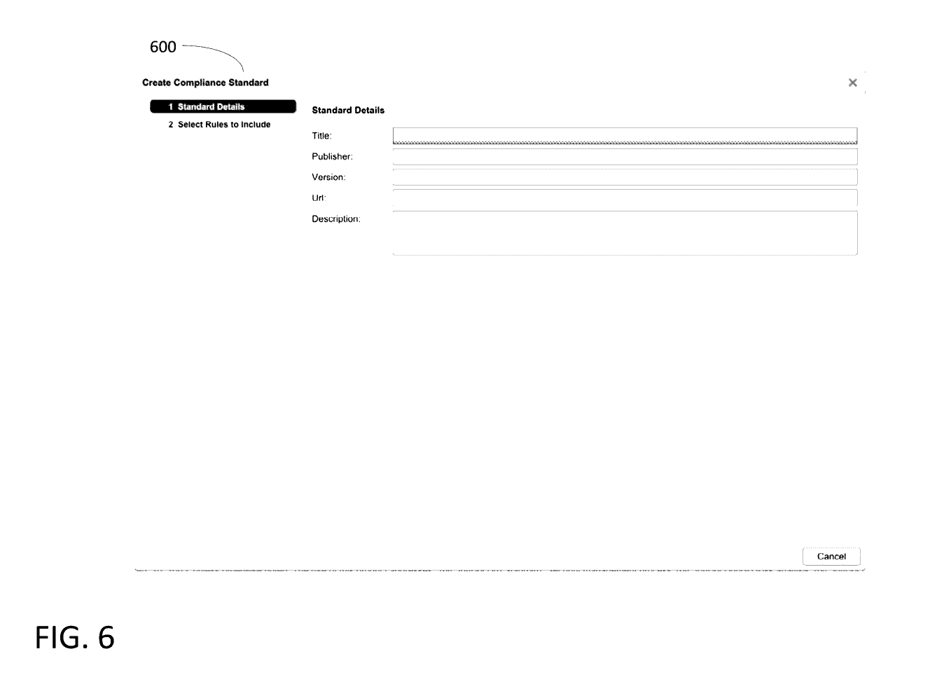

Note that the texts in the leftmost buttons are bolded, indicating the task of defining a compliance standard has been completed for each of the rows. Presentation 500 also includes a standalone “add new standard” button 520, which is used to add additional top-level rows corresponding to additional compliance standards. Triggering “add new standard” button 520 opens a “Create Compliance Standard” dialog box 600, shown in FIG. 6. A user can define a new standard by filling in the form blanks and selecting rules to include. Triggering the leftmost button of a row opens a similar dialog box, except the form fields are filled in rather than blank.

Row 502 includes a spatially ordered set of buttons 510, 522, 524, and 526. Note that buttons 510, 522, and 524 point to the right to indicate that they relate to a workflow. The order of these buttons corresponds to a normal temporal order of the corresponding tasks: defining a compliance standard, creating profiles, assigning objects to profiles, and activating profiles. Accordingly, buttons 522, 524, and 526, are labeled “Create Profiles”, “Assign Objects”, and “Activate Profiles”, respectively. All these labels are bolded, indicating all tasks associated with the PCI compliance standard are complete according to respective criteria.

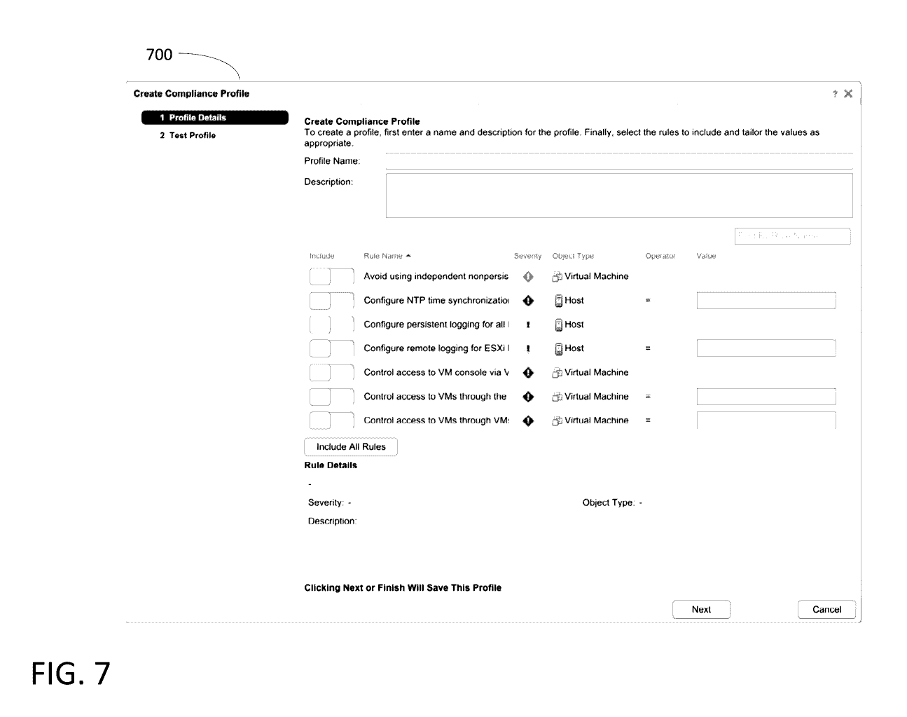

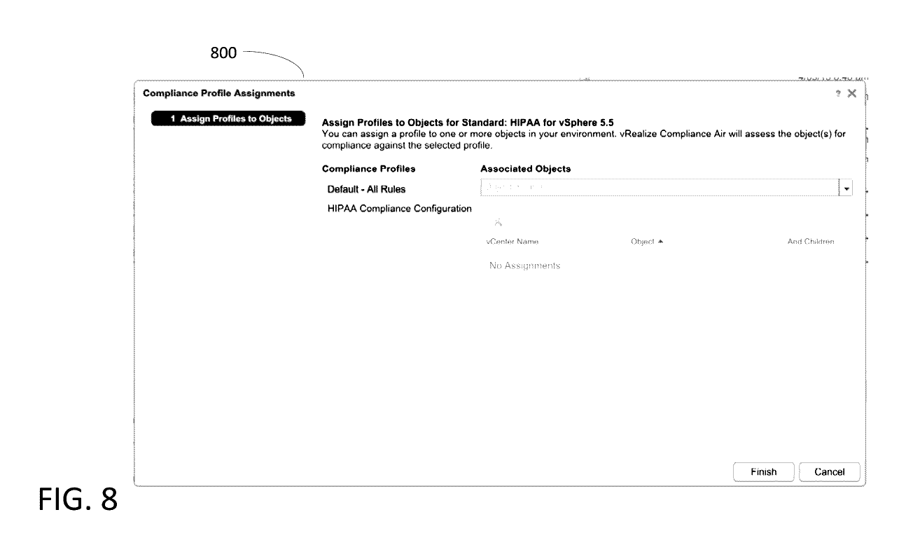

Triggering a “Create Profile Button”, such as button 522, opens a “Create Compliance Profile” dialog box 700, shown in FIG. 7. Creating a compliance profile causes a child row to be generated for the corresponding top-level row. Triggering an “Assign Objects” button, such as button 524, opens a “Compliance Profile Assignments” dialog box 800, as shown in FIG. 8. This allows computer system objects to be assigned to profiles. Triggering an “Activate Profiles” button, such as button 526, causes the profiles in any child rows of the respective parent row to be activated, e.g., monitored for compliance. In an alternative embodiment, a dialog box appears from which the profiles for a standard can be activated. Note that each dialog box 600, 700, 800, defines a procedure for completing a respective task.

To the left of each top-level row is a respective triangular button 528. At any given time, each of these triangular buttons 528 has a left-pointing orientation (see rows 506 and 508 in FIG. 5) or a downward-pointing orientation (see rows 502 and 504 in FIG. 5). Triggering (e.g., clicking on) a left-pointing triangular button expands the corresponding top-level row to expose any existing child rows, and causes the triangular button to switch to a downward-pointing orientation. Triggering a downward pointing triangular button 528 collapses an expanded top-level row to hide any existing child rows of the top-level row, and causes the triangular button to switch to a left-pointing orientation.

The triangular button 528 for row 502 is shown in FIG. 5 with a downward-pointing orientation. Correspondingly, existing child rows 530, 532, and 534 are displayed (as opposed to being hidden). Child row 530 includes spatially ordered buttons 536, 538, and 540. Leftmost button 536 of child row 530 is labeled “Gold Profile”. Next button 538 to the right is labeled “Assign Objects”, and the rightmost button 540 is labeled. “Activate”. The text of button 536 is bolded, as it is for all leftmost parent and leftmost child buttons upon their respective creations. The text of buttons 538 and 540 is regular (not bold), indicating that objects have not been assigned to the gold profile and the gold profile has not been activated. Both buttons 538 and 540 have solid outlines, indicating that both of these buttons can be triggered.

The leftmost button 542 of child row 532 is labeled “Silver Profile” and thus corresponds to a “Silver” profile created for the PCI compliance standard. The next button 544 to the right is labeled “Assign Objects” in bold, indicating that at least one object has been assigned to the Silver profile. The rightmost button 546 of child row 532 is labeled “Activated” in bold, indicating that the Silver profile has been activated for all objects assigned to the Silver profile.

The leftmost button 548 of child row 534 is labeled “Bronze Profile”, and thus corresponds with a “Bronze” profile for the PCI compliance standard. The next button 550 to the right is labeled “Assign Objects” indicating at least one object has been assigned to the Bronze profile. The rightmost button 552 is labeled “Activate” in regular (non-bold) text, indicating that the Bronze Profile has not been activated.

All buttons of parent row 502 and its children 530, 532, and 534 have solid outlines, indicating that all buttons in these rows are triggerable. Note that the “Activate Profiles” parent row button 526 is bold even though only one of three corresponding child row buttons is bold. Likewise, Assign Objects button 524 is bold, indicating completion, even though not all the corresponding child-row buttons (538, 544, and 550) indicate completion. Thus, for widget 432, a parent button indicates complete if any of the corresponding child buttons indicates complete.

In any case, child-button indications “bubble up” to the parent is buttons according to some Boolean (e.g., and, or) or other function. The function is the same whether the child rows are displayed or hidden. If parent row 502 were collapsed., e.g., by toggling triangular button 528, parent row 502 would not be changed. Bolding in the parent row, in a sense, summarizes, the child row states, with bold being used for any parent-row button for which at least one corresponding child-row button indicates completion. In other embodiments, all corresponding buttons must indicate completion for the parent row button to indicate completion. In other embodiments, there are other relations between a parent row button indicating completion and the indications of the corresponding child-row buttons.

The “Gold”, “Silver”, and “Bronze” profile names are intended to indicate different degrees of adoption of the PCI compliance standard. “Gold” can indicate profiles that exceed the PCI standard. “Silver” can indicate that the PCI standard is met. “Bronze” can indicate that only a given subset of the rules for the PCI standard need be met. Elsewhere, other relations between the compliance profiles and standards are used.

HIPAA standard row 504 includes a “Create Profiles” button 554, an “Assign Objects” button 556, and an “Activate Profiles” button 558. For all top-level rows 502, 504, 506, and 508, the rightmost three buttons have the same text in the labels. Row 504 has two child rows 560 and 562. Leftmost button 564 of child row 560 is labeled “Enhanced Profile”, so child row 560 corresponds to an Enhanced profile for the HIPAA compliance standard. Assign Objects button 566 and Activate button 568 of child row 560 indicate their respective tasks are incomplete.

The leftmost button 570 of child row 562 is labeled. “Basic Profile”, so child row 570 relates to a “Basic” profile for the HIPAA compliance standard. “Assign Objects” button 572 is bolded, indicating that at least one object has been assigned to the Basic profile. Activate button 574 is not bold, indicating that the Basic profile for the HIPAA compliance standard has not been activated.

Note that the Activate Profile button 558 for parent row 504 is unbolded, corresponding to the fact that all corresponding child buttons 568 and 574 indicate no profile has been activated for the HIPAA compliance standard. However, all buttons for rows 504, 560, and 562, are triggerable, as indicated by the solid outlines used throughout.

Note that there are no profiles in common between the PCI compliance standard and the HIPAA compliance standard. This non-overlap of profiles is expected in the compliance standards context, since each profile is based on the rules of the associated standard. However, in other contexts, child rows could overlap or match between parent rows. For example, in an embodiment in which the top-level rows correspond to performance parameters, and the profiles are system configurations, the same configuration could be presented for evaluation according to all performance parameters.

The vSphere Hardening parent row 506 is collapsed, as indicated by the rightward orientation of the corresponding triangular button 528. Row 506 includes a Create Profiles button 576, an Assign Objects button 578, and an Activate Profiles button 580. Create Profiles button 576 is bold, indicating that at least one profile has been created for the vSphere Hardening compliance standard. Of course, this profile is hidden since row 506 is collapsed. The Assign objects button 578 and the Activate Profile button 580 are triggerable, although the tasks to which they correspond are not complete, as indicated by the lack of bolding on those buttons.

User1 compliance standard row 508 is collapsed, as indicated by the right-pointing orientation of triangular button 528 for row 508. Parent row 508 includes a “Create Profiles” button 582, an “Assign Objects” button 584, and an Activate Profiles button 586. None of these buttons have bolded text, so no profiles have been created for the User1 compliance standard. The outlines of the Assign Objects button 584 and the Activate Profile Button 586 are dashed indicating buttons 584 and 586 are disabled, i.e., not triggerable. The reasons they are not triggerable is that no profile for the User1 compliance standard has been created, so no objects can be assigned to a profile and there is no profile to activate.

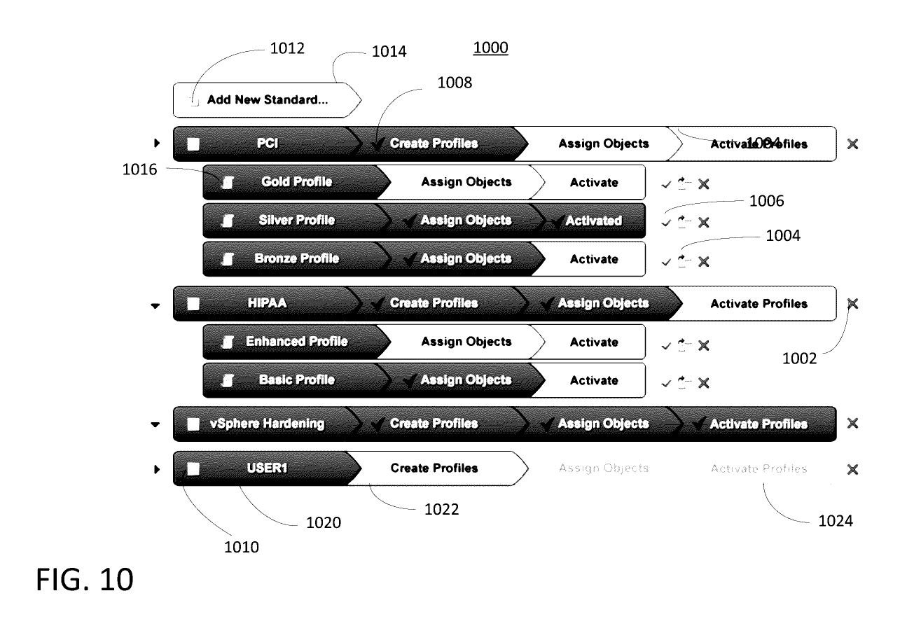

In presentation 500, bolding is used to indicate whether or not a task is complete, and dashed outlining is used to indicate buttons that are not triggerable. However, in practice, colors, icons, textures, borders, etc. can be used to indicate button states. Thus, the workflow state represented in FIG. 5 can be alternatively represented. as presentation 1000, shown in FIG. 10.

As with presentation 500, all but the last button in each row of presentation 1000 point to the right to make it clear that a workflow is represented. In other embodiments, spatial sequences other than rows are used. For example, wrap-around, columnar, and curvilinear arrangements of buttons can be employed for some applications.

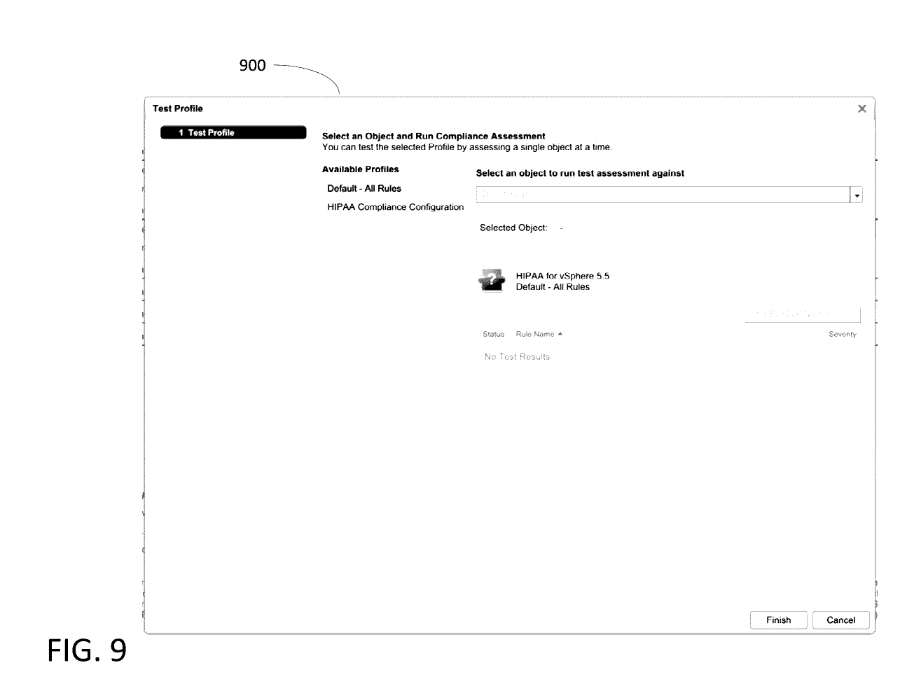

Presentation 1000 includes some icons not used in presentation 500. X's 1002 are used at the ends of rows as buttons for deleting respective rows. Another icon 1004 is used to copy a profile, e.g., to use as a template for a new profile. A third additional. icon 1006 is used to trigger a test of a profile without fully activating a profile. In other words, triggering icon 1006 calls dialog box 900 of FIG. 9. Checkmarks 1008 reinforce the indication that a respective task has been completed. Icons 1010 indicate that the leftmost buttons of top-level rows represent compliance standards; thus, the similar icon 1012 in the “Add New Standard” button 1014 indicates that triggering will add a new compliance standard. Icons 1016 indicate that the leftmost buttons of child rows represent compliance profiles.

In terms of the button color scheme, completed tasks are white on green as on button 1020. Incomplete but active buttons are black on white, as on button 1022. Disabled buttons are dark grey on light grey, as on button 1024.

Note that for presentations 500 and 1000, the number (3) of buttons in a child row is one less than the number (4) of buttons in the respective parent row. In fact, there is a one-to-one correspondence between the last three buttons of the parent row and the buttons of the child row. However, in other embodiments, there can be buttons in a child row that have no counterpart in the parent row and/or buttons in the parent row that have no counterpart in the child row. For example, a parent row can have buttons for assigning attributes to a compliance standard, while child rows would lack corresponding buttons. Likewise, a child row could have buttons for profile attributes, which the respective parent row would lack. Note, also, that all buttons of a row, other than the last button of a row, point to the right to make it apparent that the presentation 1000 pertains to a workflow.

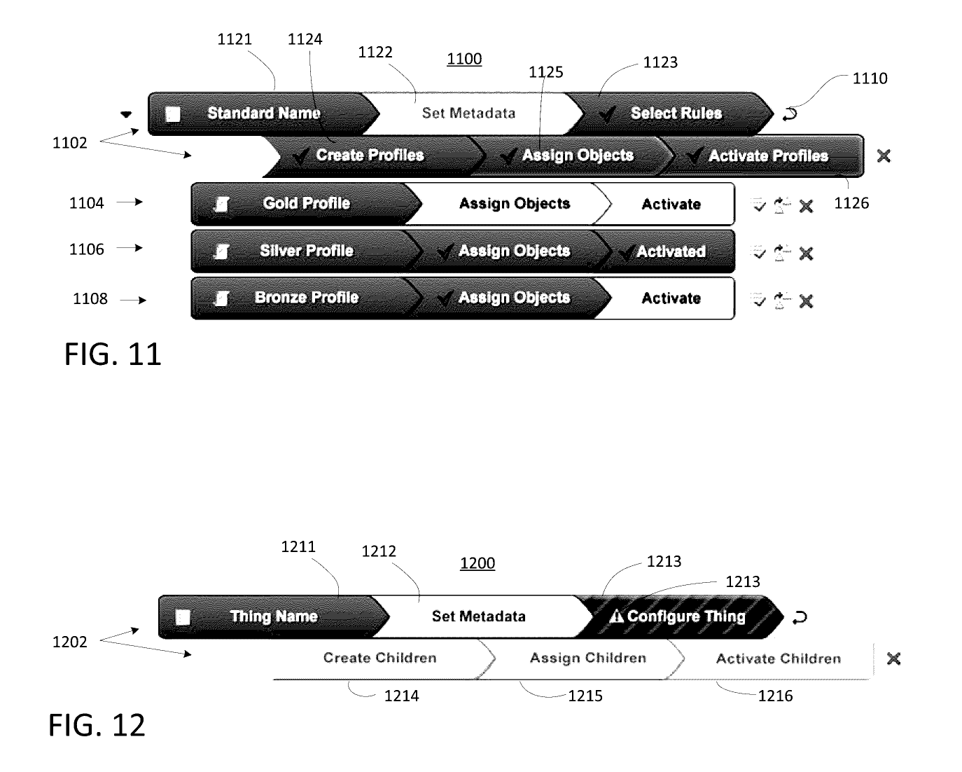

Accordingly, in presentation 1100, shown in FIG. 11, there is one top-level parent row 1102 and three child rows 1104, 1106, and 1108. Child rows 1104, 1106, and 1108 are essentially the same as child rows of presentation 1000 of FIG. 10. Parent row 1102 is wrapped, as indicated, by curved arrow 1110. Accordingly, the spatial order of the buttons of row 1102 is as listed here: buttons 1121, 1122, 1123, 1124, 1125, and 1126. “Set Metadata” button 1122 and “Select Rules” button 1123 have no counterparts in child rows 1104, 1106, and 1108. Button 1122 corresponds to a task that is not required; to distinguish it, button 1122 uses grey text on a background with yellow-green hatching.

Presentation 1200 has one wrap-around row 1202 with six buttons 1211, 1212, 1213, 1214, 1215, and 1216, in that spatial order. “Configure Thing” button 1213 is red and textured with a warning sign 1218 to warn that Thing Name (button 1211) is not validly configured. For this reason, buttons 1214, 1215, and 1216 are disabled (not triggerable).

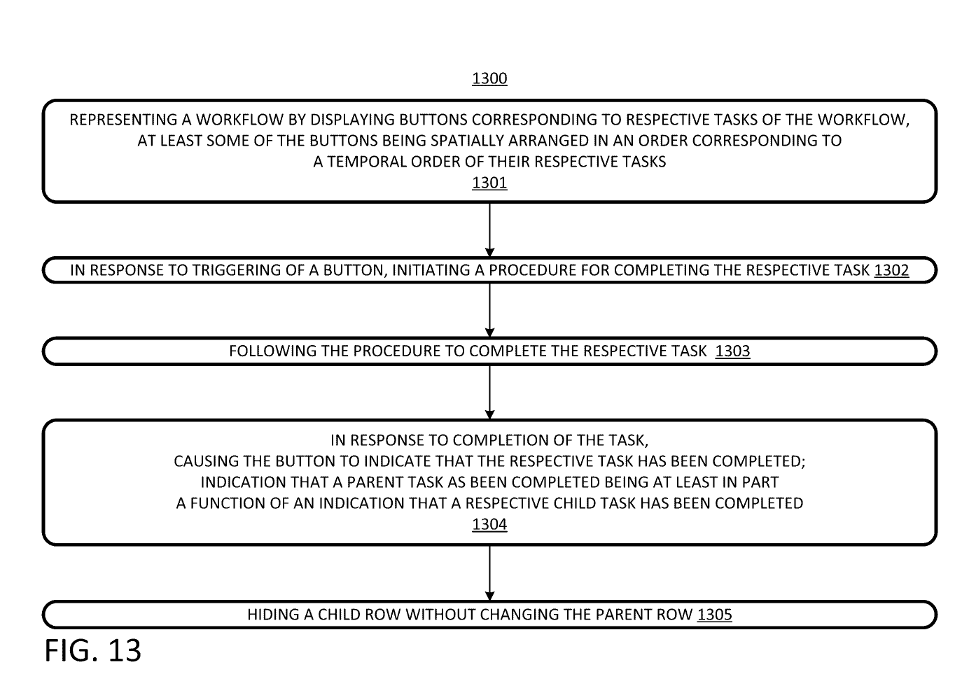

A workflow guidance process 1300, flow-charted in FIG. 13, is implementable in system 400 (FIG. 4) and other systems. At 1301, a workflow is represented by displaying buttons corresponding to respective tasks of the workflow. At least some of the buttons are spatially arranged in an order corresponding to a temporal order of their respective tasks.

At 1302, in response to triggering of a button, a procedure is initiated for completing the respective task. At 1303, the procedure is followed to complete the task, e.g., according to a respective completion criterion.

At 1304, in response to completion of the task, causing the button to indicate that the respective task has been completed. All buttons indicate whether or not their respective tasks are complete. In some embodiments, an indication by a parent button that its task is complete is a function of indications by a child button (a button in a child row corresponding to a button in the parent row) that its respective task is complete. At 1305, a child row is hidden without changing the buttons of the respective parent row.

In an alternative embodiment, the top-level rows conform to performance parameters for a computer system. Performance can include transaction rates, response times, uptime percentages, error rates, etc. Child rows can correspond to performance thresholds. Computer components can be assigned to performance thresholds. Activating a configuration can result in measurements indicating a degree to which a computer system's components meet an assigned to performance threshold. Other applications can likewise take advantage of the workflow guidance widget.

Herein, “system” refers to a set of interacting elements, wherein the elements can be, by way of example, and not of limitation, computer components, physical encoding of computer data and instructions, atoms, actions. A process is a system for which the elements are actions. Herein, “storage media” implies the media is non-transitory.

Herein, a “computer” is a machine or set of machines (e.g., in a server-client relationship) including a processor, communications devices, and storage media, wherein the processor executes computer-executable code stored by the storage media. A “processor” is a hardware device for executing instructions; for example, a processor can be in the form of an integrated circuit, part of an integrated circuit, or plural integrated circuits. “Communications devices” can include network interfaces and input/output devices such as keyboards, mice, and displays. Herein, a “display” is a visual interface between a computer and a human. For example, a liquid crystal display (LCD) monitor can be a display.

Herein, a “task” is a piece of work to be done or undertaken. A task can be simple or complex, e.g., composed of a set of subtasks or child tasks. Herein, “completed” means that a task has met some threshold for completion. “Completed” does not necessarily imply there is nothing more to do on the task. For example, a parent task may be considered complete when one corresponding child task has been completed, even though another corresponding child task has yet to be completed. Furthermore, a previously completed task may be revisited, and completed again, e.g., by modifying the result of the previously completed task.

Herein, a “button” is a software-based user interface element that emulates a machine button, i.e., a small part or area of a machine that is pressed to make it do something. Typically, a user-interface button is “pressed” and, thereby, triggered, by clicking on it using a mouse or other user input device.

Herein, “temporal order” is order in time. The temporal order may be actual or planned. If planned, a subsequent actual temporal order may or may not match the planned temporal order. A “workflow” is a temporal arrangement of tasks. A workflow may be simple in that each pair of tasks is temporally ordered. Alternatively, a workflow may have branches, such that each pair of tasks in the same branch are temporally ordered but pairs of tasks from different branches are not necessarily temporally ordered.

Herein, “spatial order” refers to an order in space. For example, buttons can be spatially ordered in a row (e.g., from left to right), in a column (e.g., from top to bottom), along a curved path, or in plural rows using wraparound. In a “wraparound” spatial arrangement, the first button of a succeeding row immediately follows the last button of the preceding row.

The foregoing and other variations upon and modification to the foregoing embodiments are provided for by the present invention, the scope of which is defined by the following claims.

What is claimed is:

1. A system comprising non-transitory media encoded with code that, when executed using hardware, implements a process including:
representing a workflow by displaying buttons, each of which, when triggered, initiates a procedure for completing a respective task of the workflow, at least one set of the buttons being spatially arranged in an order matching a temporal order for the respective tasks;
triggering a button so as to initiate a procedure for completing the respective task;
following the procedure to complete the respective task; and
in response to completion of the task, causing the button to indicate that the respective task has been completed.

2. The system of claim 1 wherein the process further causes each of the buttons to indicate whether or not it can be triggered without first completing a non-respective task.

3. The system of claim 1 wherein the buttons are arranged in plural spatial sequences such that, within each spatial sequence, buttons are arranged in a spatial. order corresponding to the temporal order of the respective tasks.

4. The system of claim 3 wherein the spatial sequences are arranged hierarchically in that at least one spatial sequence is a parent spatial sequence with at least one child spatial sequence.

5. The system of claim 4 wherein the parent spatial sequence includes a button that indicates whether or not the respective task has been completed based on indications of whether or not a task has been completed for one or more buttons in one or more child spatial sequences of the parent spatial sequence.

6. A workflow guidance process comprising:
representing a workflow by displaying buttons, each of which, when triggered, initiates a procedure for completing a respective task of the workflow, at least one set of the buttons being spatially arranged in an order matching a temporal order for the respective tasks;
triggering a button so as to initiate a procedure for completing the respective task;
following the procedure to complete the respective task; and
in response to completion of the task, causing the button to indicate that the respective task has been completed.

7. The process of claim 6 wherein each of the buttons indicates whether or not it can be triggered without first completing a non-respective task.

8. The process of claim 6 wherein the buttons are arranged in plural spatial sequences such that, within each spatial sequence, buttons are arranged in a spatial order corresponding to the temporal order of the respective tasks.

9. The process of claim 8 wherein the spatial sequences are arranged hierarchically in that at least one spatial sequence is a parent spatial sequence with at least one child spatial sequence.

10. The process of claim 9 wherein the parent spatial sequence includes a button that indicates whether or not the respective task has been completed based on indications of whether or not a task has been completed for one or more buttons in one or more child spatial sequences of the parent spatial sequence.

11 A system comprising:
a display; and
a computer for causing the display to present a first spatially ordered set of buttons, each of the buttons, when triggered, initiating a procedure for completing a respective task, each of the buttons indicating, at any given time, whether or not the respective task has been completed.

12. The system of claim 11 wherein the buttons collectively correspond to a first temporally ordered set of tasks of a workflow.

13. The system of claim 12 wherein the computer further causes the display to display a second spatially ordered set of buttons corresponding to a second set of temporally ordered set of tasks, the temporal order of the second temporally ordered set being independent of the temporal order of the first set.

14. The system of claim 12 wherein the computer further causes the display to display a second spatially ordered set of buttons corresponding to a second set of temporally ordered set of tasks, at least one of the buttons of the first spatially ordered set indicating whether or not the respective task has been completed at least in part as a function of whether or not a button of the second spatially ordered set indicates a respective task has been completed.
